(19) United States
(12) Patent Application Publication
(10) Pub. No.: US 2025/0292404 A1
(43) Pub. Date: Sep. 18, 2025

(54) MEDICAL INFORMATION PROCESSING APPARATUS, MEDICAL INFORMATION PROCESSING SYSTEM, MEDICAL INFORMATION PROCESSING METHOD, AND STORAGE MEDIUM

(71) Applicant: Konica Minolta, Inc., Tokyo (JP)

(72) Inventor: Eiichi AKAGI, Tokyo (JP)

(21) Appl. No.: 19/080,149

(22) Filed: Mar. 14, 2025

(30) Foreign Application Priority Data
Mar. 18, 2024 (JP) 2024-041865

(51) Int. Cl. G06T 7/00

(52) U.S. Cl. CPC G06T 7/0012; G06T 2207/10072; G06T 2207/10132; G06T 2207/20081; G06T 2207/30096

(57) ABSTRACT

A medical information processing apparatus includes, an image acquirer that acquires a medical image; and a hardware processor that determines whether to perform lesion detection processing by a computer on the medical image. The hardware processor determines whether to perform the lesion detection processing based on at least a condition as to whether specific image processing has been performed, or determines whether to perform the lesion detection processing using a trained model.

### BACKGROUND OF THE INVENTION

### Technical Field

The present invention relates to a medical information processing apparatus, a medical information processing system, a medical information processing method, and a storage medium.

### Description of Related Art

There is an artificial intelligence (AI) analysis system that analyzes a medical image acquired by a modality such as a radiation image apparatus using AI and provides a doctor with an analysis result of the medical image, thereby supporting the doctor's diagnosis. In the AI analysis system, image analysis is performed using a medical image sent from a server or the like, but the medical image may include an image inappropriate for AI analysis. In such a case, there is a risk of providing an inaccurate analysis result to the doctor.

Japanese Patent No. 7035569 describes a medical image processing apparatus that determines whether a medical image is an image to be processed. The medical image processing apparatus determines whether or not the medical image is an image to be processed by predetermined processing on the basis of a determination result of at least one of an imaging site and an imaging direction of the medical image. Next, the medical image processing apparatus performs rib attenuation processing, lesion detection processing, and the like on the medical image determined to be an image to be processed.

However, when the conventional technique is applied to the AI analysis, the following problems occur. A conventional medical image processing apparatus determines whether a medical image is an image to be processed by predetermined processing based on a determination result of an imaging site and an imaging direction of the medical image. Therefore, even a medical image that is inappropriate for AI analysis, such as a bone attenuation processing image, may be determined to be an appropriate medical image if the medical image satisfies conditions such as the imaging site.

### SUMMARY OF THE INVENTION

Therefore, in order to solve the above-described problem, an object of the present invention is to provide a medical information processing apparatus, a medical information processing system, a medical information processing method, and a storage medium including a program which can provide only medical images suitable for lesion analysis processing when the lesion analysis processing is performed by a computer.

A medical information processing apparatus according to the present invention includes
an image acquirer that acquires a medical image; and
a hardware processor that determines whether to perform lesion detection processing by a computer on the medical image,
wherein the hardware processor determines whether to perform the lesion detection processing based on at least a condition as to whether specific image processing has been performed, or determines whether to perform the lesion detection processing using a trained model.

A medical information processing system according to the present invention includes
an image acquirer that acquires a medical image; and
a hardware processor that determines whether to perform lesion detection processing by a computer on the medical image,
wherein the hardware processor determines whether to perform the lesion detection processing based on at least a condition as to whether specific image processing has been performed, or determines whether to perform the lesion detection processing using a trained model.

A medical information processing method according to the present invention includes the steps of:
acquiring a medical image; and
determining whether to perform lesion detection processing by a computer on the medical image,
wherein, in the determining, whether to perform the lesion detection processing is determined based on at least a condition as to whether specific image processing has been performed, or whether to perform the lesion detection processing is determined using a trained model.

A non-transitory computer-readable storage medium storing a program that causes a computer to perform:
acquiring a medical image, and
determining whether to perform lesion detection processing by a computer on the medical image,
wherein, in the determining, whether to perform the lesion detection processing is determined based on at least a condition as to whether specific image processing has been performed, or whether to perform the lesion detection processing is determined using a trained model.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram showing an example of a schematic configuration of a medical information processing system according to a first embodiment;

FIG. 2A is an example of a block diagram of a mediation apparatus according to the first embodiment;

FIG. 2B is a diagram illustrating an example of a digital marker added to a medical image that is a radiation image according to the first embodiment;

FIG. 3 is a diagram illustrating an example of a block diagram of an image storage apparatus according to the first embodiment;

FIG. 4 is a flowchart showing an example of the operation of the medical information processing system in a case of determining whether or not to execute lesion detection processing on a medical image based on a rule according to the first embodiment;

FIG. 5A is a diagram illustrating an example of lesion analysis failure information displayed on a display part of a client terminal of the image storage apparatus according to the first embodiment;

FIG. 5B is a diagram illustrating another example of the lesion analysis failure information displayed on the display part of the client terminal of the image storage apparatus according to the first embodiment;

FIG. 6 is a flowchart showing an example of an operation of the medical information processing system in a case of determining whether or not to execute the lesion detection processing using a trained model according to the first embodiment;

FIG. 7 is a flowchart illustrating an example of an operation of the medical information processing system in a case in which the determination on whether to perform the lesion detection processing using the rule-based and using the trained model are combined according to the first embodiment;

FIG. 8 is a flowchart illustrating an example of an operation of the medical information processing system in a case in which the lesion detection processing is performed by the trained model according to the first embodiment;

FIG. 9 is a diagram showing an example of a schematic configuration of the medical information processing system according to a second embodiment;

FIG. 10 is a diagram showing an example of a schematic configuration of the medical information processing system according to a third embodiment;

FIG. 11 is a block diagram of an image imaging storage apparatus according to the third embodiment; and

FIG. 12 is a diagram illustrating a block diagram of the image imaging storage apparatus according to the third embodiment.

### DETAILED DESCRIPTION

Hereinafter, one or more embodiments of the present invention will be described with reference to the drawings. However, the scope of the invention is not limited to the disclosed embodiments.

In the following, a preferred embodiment of the present disclosure will be described in detail with reference to the accompanying drawings.

### [Example Configuration of Medical Information Processing System 100A]

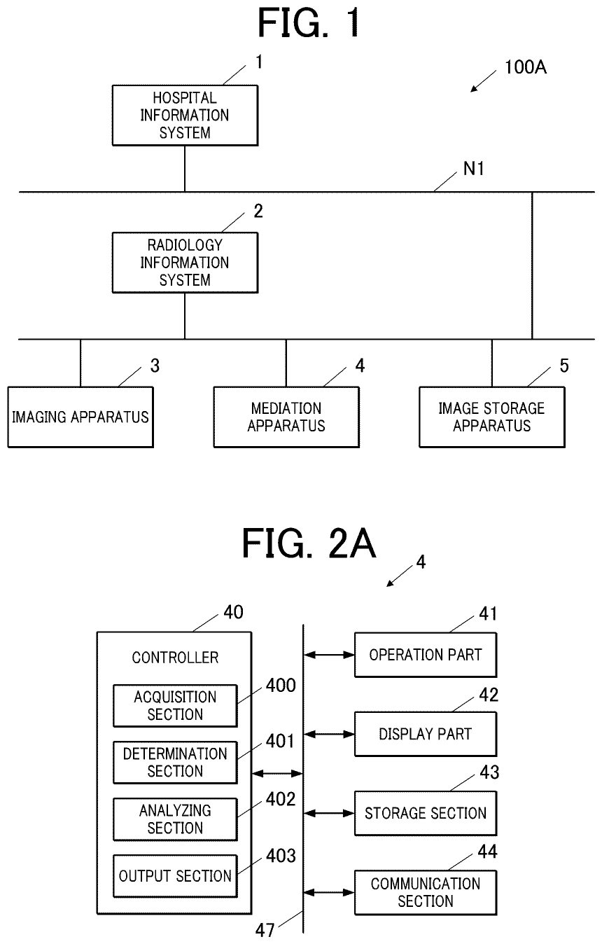

FIG. 1 is a diagram illustrating an example of a schematic configuration of a medical information processing system 100A according to a first embodiment. The medical information processing system 100A includes a hospital information system 1, a radiology information system 2, an imaging apparatus 3, a mediation apparatus 4, and an image storage apparatus 5. The hospital information system 1, the radiology information system 2, the imaging apparatus 3, the mediation apparatus 4, and the image storage apparatus 5 are communicably connected to each other via a network N1 constructed in a medical institution. The network N1 includes, for example, a local area network (LAN). LAN is an abbreviation for Local Area Network. The network N1 may be wired communication or wireless communication. The respective systems and apparatuses mutually transmit and receive image data such as medical images in accordance with a DICOM standard. DICOM is an abbreviation for Digital Imaging and Communication in Medicine.

The hospital information system 1 is a system that manages medical care, accounting tasks, electronic medical records, and the like of the entire medical institution. The hospital information system 1 transmits, to the imaging apparatus 3 or the like, an examination order such as an examination to be performed by a doctor, a nurse, or the like, or a prescription, for example. The hospital information system 1 is referred to as HIS. HIS is an abbreviation for Hospital Information System.

The radiology information system 2 is a system that organizes imaging information such as examination order reservations, irradiation record management, and examination service statistics into a database and manages the database, mainly in the radiology department. The radiology information system 2 transmits, for example, an examination order such as an examination or a prescription to be performed by the doctor, the nurse, or the like, to the imaging apparatus 3 or the like. The radiology information system 2 can cooperate with the hospital information system 1. The hospital information system 1 and the radiology information system 2 may be integrated to construct one system. The radiology information system 2 is referred to as an RIS. RIS is an abbreviation for Radiology Information System.

The imaging apparatus 3 images a subject based on the examination order received from the hospital information system 1 or the radiology information system 2, and generates a medical image of a predetermined imaging site or the like. The imaging apparatus 3 is, for example, a CR apparatus, an FPD apparatus, a CT apparatus, or an MRI apparatus. The medical image is, for example, a radiation image. CR is an abbreviation for Computed Radiography. FPD is an abbreviation for Flat Panel Detector. CT is an abbreviation for Computed Tomography. MRI is an abbreviation for Magnetic Resonance Imaging. The imaging apparatus 3 may perform specific image processing on the generated medical image. The specific image processing includes, for example, bone attenuation processing, as will be described later.

The imaging apparatus 3 transmits the generated medical image to the mediation apparatus 4 in a file format conforming to the DICOM standard. Here, the file of the DICOM standard includes an image part and a header part. Actual data of the medical image is written in the image part. Supplementary information related to the medical image is written in the header part. In the supplementary information, for example, patient information, examination information, a UID for uniquely identifying the medical image, information indicating whether specific image processing has been performed, and the like are written. The patient information includes patient identification information such as a patient ID for identifying the patient, and information such as the name, sex, and date of birth of the patient. The examination information includes examination identification information such as an examination ID for identifying an examination, an examination date, an imaging site, an imaging direction, modality information, and the like.

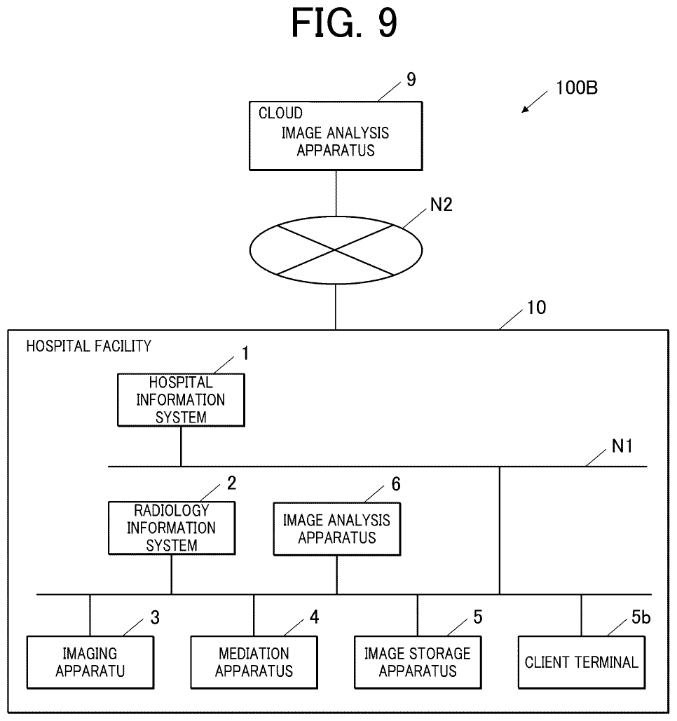

The mediation apparatus 4 is an example of a medical information processing apparatus and is referred to as, for example, a gateway. The mediation apparatus 4 determines whether to perform computer-implemented lesion detection processing on the medical image transmitted from the imaging apparatus 3. The computer-implemented lesion detection processing is, for example, processing for determining, using a trained model created by machine learning or deep learning that is a type of machine learning, whether a medical image is suitable for the computer-implemented lesion detection processing. The mediation apparatus 4 determines whether to perform lesion detection processing on the basis of at least a condition indicating whether specific image processing has been performed, or determines whether to perform lesion detection processing using the trained model. The mediation apparatus 4 performs computer-implemented lesion detection processing on the medical image and generates an analysis result thereof. The mediation apparatus 4 transmits the generated analysis result to the image storage apparatus 5 together with the medical image. In the present embodiment, a case where the mediation apparatus 4 determines whether or not to perform the computer-implemented lesion detection processing will be described, but the present invention is not limited thereto. For example, the determination of whether or not to perform the computer-implemented lesion detection processing may be performed by the imaging apparatus 3, the image storage apparatus 5, or the like, or may be performed by an image imaging storage apparatus in which the imaging apparatus 3 and the image storage apparatus 5 are integrated. In addition, the determination of whether or not to perform the computer-implemented lesion detection processing may be performed by the image analysis apparatus 9 (see FIG. 9) or the like provided on the cloud.

The image storage apparatus 5 stores and manages the image data of the medical image, the supplementary information thereof, and the like transmitted from the mediation apparatus 4. The image storage apparatus 5 stores and manages the analysis result of the lesion analysis processing transmitted from the mediation apparatus 4. The image storage apparatus 5 reads the corresponding medical image in response to a search request for a predetermined medical image by a user such as the doctor, and transmits the read medical image to a client terminal, a viewer, or the like as a request source.

Note that in the medical information processing system 100A, the imaging apparatus 3 transmits the medical image to the mediation apparatus 4, and the mediation apparatus 4 transmits the medical image and the analysis result thereof to the image storage apparatus 5, but it is not limited thereto. For example, the imaging apparatus 3 may transmit the medical image to both the mediation apparatus 4 and the image storage apparatus 5, and the mediation apparatus 4 may transmit only the analysis result of the medical image to the image storage apparatus 5.

### [Example of Configuration of Mediation Apparatus 4]

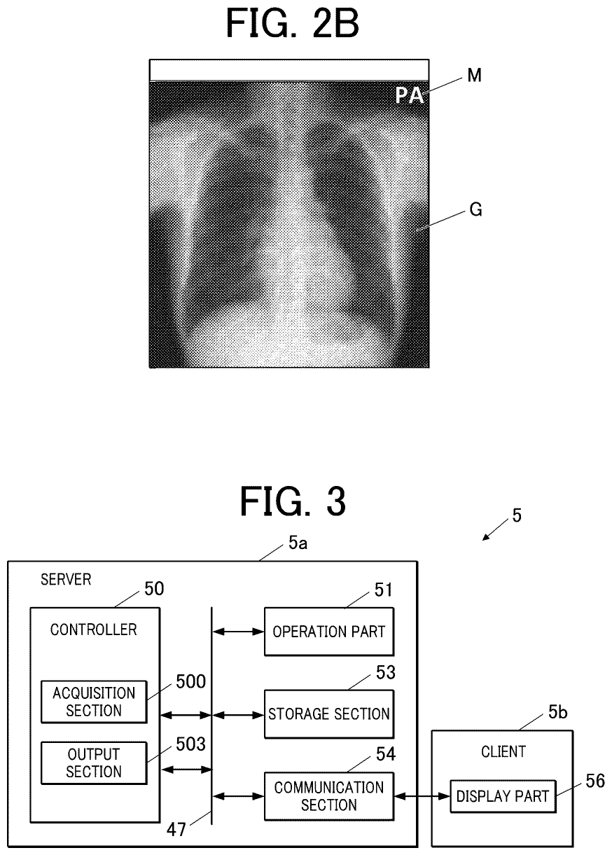

Next, a configuration of the mediation apparatus 4 according to the first embodiment will be described. FIG. 2A is a block diagram of the mediation apparatus 4 according to the first embodiment. The mediation apparatus 4 includes a controller 40 (hardware processor), an operation part 41, a display part 42, a storage section 43, and a communication section 44. The controller 40, the operation part 41, the display part 42, the storage section 43, and the communication section 44 are connected to each other via wiring such as a bus 47.

The controller 40 includes, for example, a processor, such as a CPU that performs calculations and control, and a memory. CPU is an abbreviation for Central Processing Unit. The controller 40 realizes, for example, by executing the program stored in the storage section 43 or the like, processing for determining whether or not to perform the computer-implemented lesion detection processing on the medical image.

The controller 40 may include an electronic circuit, such as an ASIC or an FPGA. ASIC is an abbreviation of Application Specific Integrated Circuit. FPGA is an abbreviation for Field Programmable Gate Array.

In the present embodiment, the controller 40 functions as an acquisition section 400, a determination section 401, an analyzing section 402, and an output section 403. The processor or the like of the controller 40 realizes each function of the acquisition section 400, the determination section 401, the analyzing section 402, and the output section 403 by executing a program stored in the storage section 43 or the like. Note that details of each function of the controller 40 will be given later.

The operation part 41 includes, for example, a mouse, a keyboard, a switch, and a button. The operation part 41 may be, for example, a touch screen integrally combined with a display or may be an interface that accepts a voice input. The operation part 41 accepts instructions corresponding to various types of input operation from the user, converts the accepted instruction into an operation signal, and outputs the operation signal to the controller 40.

Specifically, the operation part 41 accepts, for example, an instruction to select whether to perform the computer-implemented lesion detection processing on the medical image that may include the foreign object.

The display part 42 is, for example, a liquid crystal display, an organic EL display, or the like. EL is an abbreviation for Electro Luminescence. The display part 42 displays an image on which predetermined analysis processing has been performed, a GUI for accepting various input operations by a user, and so forth. GUI is an abbreviation for Graphical User Interface. Specifically, the display part 42 displays a message or the like for notifying the user that there is a possibility that the foreign object appears in the medical image.

The storage section 43 includes, for example, any storage module such as an HDD, an SSD, a ROM, and a RAM. HDD is an abbreviation of Hard Disk Drive. SSD is an abbreviation of Solid State Drive. ROM is an abbreviation of Read Only Memory. The storage section 43 stores, for example, a system program, an application program, and various types of data. More specifically, the storage section 43 stores a program for determining whether to perform the computer-implemented lesion detection processing on the medical image, and image data of the medical image imaged by the imaging apparatus 3. The storage section 43 stores the trained model or the like that outputs a determination result as to whether to perform the computer-implemented lesion detection processing on the medical image.

The communication section 44 includes, for example, a communication module including an NIC, a receiver, and a transmitter. NIC is an abbreviation for Network Interface Card. The communication section 44 communicates various kinds of information and image data with the imaging apparatus 3, the image storage apparatus 5, and the like via the network N1.

Note that the configuration of the mediation apparatus 4 is not limited to the configuration illustrated in FIG. 2A. For example, the mediation apparatus 4 may not include the operation part 41 and the display part 42. In this case, the mediation apparatus 4 automatically processes the medical image transmitted from the imaging apparatus 3 without receiving an instruction from the user, and transmits the analysis result of the processed medical image to the image storage apparatus 5.

### [Functional Example of Mediation Apparatus 4]

Next, functions of the acquisition section 400, the determination section 401, the analyzing section 402, and the output section 403 of the controller 40 of the mediation apparatus 4 will be described in detail. According to the present embodiment, the controller 40 determines whether or not to perform the computer-implemented lesion detection processing on the medical image. Specifically, the determination section 401 determines whether to perform the lesion detection processing on the basis of at least a condition indicating whether specific image processing has been performed, or determines whether to perform the lesion detection processing using the trained model.

The communication section 44 functions as an image acquisition section (image acquirer), and acquires the medical image captured by the imaging apparatus 3. The acquisition section 400 acquires supplementary information on whether or not specific image processing has been performed, and the like, by the supplementary information of the medical image or image recognition on the medical image. The supplementary information of the medical image is tag information of the medical image, and information managed in a database separately from the medical image and held in association with the medical image.

Specifically, the acquisition section 400 acquires at least one of the following pieces of information from the tag information of the medical image. The information is information indicating whether or not specific image processing has been performed, whether or not it is the standard imaging conditions, whether or not the medical image satisfies specific image quality conditions, and whether or not the medical image is an image imaged by a modality other than a specific modality.

The acquisition section 400 acquires at least one piece of information described below by performing the image recognition on the medical image. The information is information indicating whether or not specific image processing has been performed, whether or not it is the standard imaging conditions, whether or not the medical image satisfies specific image quality conditions, and whether or not a detection target site that is a detection target of the lesion detection processing includes a defect. The other information includes information indicating whether or not a foreign object that is not a target of detection is included in the medical image, and whether or not the medical image is the image imaged by a modality other than the specific modality.

Among the above-described information, information indicating whether or not the detection target site to be the detection target of the lesion detection processing includes the defect and information indicating whether or not a foreign object to be excluded from the detection target is included in the medical image can be basically acquired only by image recognition. Whether or not the detection site to be the detection target of the lesion detection processing includes the defect may be determined by whether or not there is the defect in the lung field region in the lesion detection processing of the chest. Whether or not the medical image includes the foreign object that is not to be the target of detection may be determined by whether or not the medical image includes a low signal value region that is estimated to be the foreign object by histogram analysis.

The acquisition section 400 may acquire the information indicating whether or not the specific image processing has been performed and the like from the information included in the hospital information system 1 or the information included in the radiology information system 2. Hereinafter, the information included in the hospital information system 1 is referred to as HIS information, and the information included in the radiology information system 2 is referred to as RIS information. The supplementary information of the medical image may not include sufficient information for determining whether to perform the lesion detection processing, and it may take time and effort to perform image recognition on the medical image. The use of the HIS information or the RIS information can improve the accuracy of acquiring the information indicating whether the medical image has been subjected to the predetermined image processing.

The HIS information includes imaging instruction information, an examination order, and the like. For example, information indicating whether or not the patient is using a pacemaker can be obtained from the HIS information. In a case where the radiology information system 2 is interposed between the hospital information system 1 and the imaging apparatus 3 or the like, the HIS information may be acquired via the radiology information system 2. In the HIS information or the RIS information, information on a non-target image such as a restriction item is also stored.

The determination section 401 makes the determination on the basis of a condition as to whether or not specific image processing has been performed. Specifically, using the information acquired by the acquisition section 400 as to whether or not specific image processing has been performed, the determination section 401 determines, based on a predetermined condition, whether or not the specific image processing is image processing appropriate for the lesion detection processing. That is, this determination method determines, on a rule basis, whether to perform computer-implemented lesion detection processing.

The specific image processing is at least one processing selected from a group of processing described below. The one group of processing includes, for example, up-down and right-left inversion processing, rotation processing, white-black inversion processing, For Processing processing, bone reduction processing, and temporal difference processing. The other group of processing is, for example, energy subtraction processing, off-irradiation field blackening processing, frequency processing at a certain intensity or more, addition of a digital marker, and addition of an annotation. For example, frequency processing at a certain intensity or higher may cause a structure of the human body to be emphasized and erroneously recognized as a lesion. Digital markers and annotations are considered to be foreign objects and may affect the accuracy of lesion detection processing. FIG. 2B is a diagram illustrating an example of a digital marker M added to a medical image G that is a radiation image according to the first embodiment. The digital marker M indicating that the imaging direction of the medical image G is a PA direction is added to the medical image G showing the front of the chest acquired by the acquisition section 400. The digital marker M may be regarded as a foreign object in computer-implemented lesion detection processing. The blackening processed image is, for example, an image in which the upper end of the image is subjected to the blackening process with a width of 40 mm or more. An example of the bone attenuation-processed image includes a clavicle/rib attenuation-processed image.

The determination section 401 can determine, using the information acquired from the tag information of the medical image, whether to perform lesion detection processing on the basis of conditions such as whether specific image processing has been performed. Specifically, the determination section 401 determines whether or not the specific image processing has been performed, based on whether or not a value of “(0008,0008)_Image_Type” defined by the DICOM standard is “ORIGINAL” indicating an original image. Also, the determination section 401 determines whether or not specific image processing has been performed, depending on whether or not the value of “(0008,2111)_Derivation Description_derived description” is “BONE SUPPRESSION”.

The determination section 401 can determine, based on at least one of the following conditions, whether to perform the computer-implemented lesion detection processing on the medical image. The conditions include, for example, whether or not it is the standard imaging condition, whether or not a medical image satisfies a specific image quality condition, and whether or not a detection target site to be a detection target of the lesion detection processing is a defect. Other conditions include, for example, whether the medical image includes a foreign object that is not the detection target, and whether the medical image is the image imaged by the modality other than a specific modality. Further, another condition is whether or not imaging is performed under a specific imaging condition other than the imaging direction or the imaging site. Further, other conditions are whether or not the direction is the PA direction in the case of imaging the chest in a standing position, whether or not the direction is a AP direction in the case of imaging in the lying position or the sitting position, and whether or not the direction is a CC direction in the case of breast imaging. Note that these conditions may be added before or after the determination as to whether to perform the lesion detection processing on the basis of the condition as to whether the specific image processing has been performed and the determination as to whether to perform the lesion detection processing using the trained model.

Whether or not it is the standard imaging condition is whether or not an inclination of the medical image satisfies the condition, whether or not the medical image is a portable imaged image, whether or not the medical image is an enlarged imaged image, and whether or not the medical image is a spot imaged image.

The case in which the inclination of the medical image satisfies the condition is, for example, a case in which the inclination of the center line of a lung field is inclined by +10 degrees or more with respect to the vertical by a lung field recognition processing of the image. Whether or not a medical image is a portable imaged image can be determined by, for example, deep learning. Whether the medical image is a magnified imaged image is determined by whether the value of “(0054,0222)_View Modifier Code Sequence_field of view modifier code sequence” defined by the DICOM standard of the tag information is [Magnification].

Whether the medical image is an enlarged imaged image is determined when “(0018,1114)_Estimated Radiographic Magnification Factor_estimated X-ray imaging magnification factor” defined in the DICOM standard of the tag information is other than 1. Whether or not the medical image is the spot imaged image is determined by whether the value of “(0054,0222)_View Modifier Code Sequence_field of view modifier code sequence” defined by the DICOM standard of the tag information is “Spot Compression”.

Further, whether or not the medical image is the spot imaged image corresponds to a case where “(0018,1114)_Estimated Radiographic Magnification Factor_estimated X-ray imaging magnification” defined by the DICOM standard of the tag information is other than 1.

Furthermore, whether or not it is the standard imaging conditions includes whether or not an imaging body position of the subject of the medical image satisfies the conditions, whether or not dose information of the medical image satisfies the conditions, and whether or not the medical image is an image in which moire occurs. The inclination of the medical image includes, for example, the inclination of the lung field of the subject shown in the medical image. The determination based on the dose information of the medical image is, for example, whether or not a dose value or a dose estimation value is equal to or larger than a threshold.

A case in which the condition of the imaging body position of the subject of the medical image is satisfied is a case in which the tag information defined by the DICOM standard does not include the letters “standing position”. The case in which the radiation dose information of the medical image satisfies the condition is a case in which the radiation dose information is less than 0.5 mAs in the case of the chest front image. Whether or not moire has occurred in the medical image is determined when there are peaks at specific frequencies as a result of power spectral analysis, for example, when a peak of 50 times or more the mean signal value is detected at 2.8 cycles/mm.

Whether the medical image satisfies the specific image quality condition is, for example, whether both of the vertical and horizontal pixel intervals are 200 μm or less. In a case in which “(0028,2112) Lossy Image Compression Ratio_lossy image compression ratio” defined by the DICOM standard is equal to or more than 10, the determination section 401 determines that the medical image is inappropriate for computer-implemented lesion detection processing.

Whether or not the medical image satisfies the specific image quality condition is determined based on at least one of whether the medical image is a film digitized image, whether or not the resolution of the medical image satisfies the condition, and whether or not lossy compression processing is being performed.

Whether or not the detection target site to be the detection target of the lesion detection processing includes a defect is at least one of whether or not the medical image is a lung field defect image and whether or not it is the image in which the imaging target site is cut out of the medical image.

Whether the medical image includes the foreign object that is not to be the detection target is determined by at least one of whether the medical image contains a foreign object other than a living body and whether the medical image includes a large lesion. The foreign object other than the living body is, for example, at least one selected from a pacemaker, a wire, a backbone fixing corset, a post-operative trace, post-funnel chest surgery, a wristwatch, underwear metal, earring, a marker, a compress, and silicon. The marker includes a marker in the lung field, a metal marker placed in the breast, and the like.

Whether the medical image is the image imaged by the modality other than the specific modality is whether the medical image is at least one of a tomographic imaged image, an ultrasonic image, and a moving image. Specifically, it is finalized whether or not the medical image is the image imaged by the modality other than the specific modality in accordance with whether or not the medical image is the image imaged by the modality different from the modality that imaged the medical image used as the learning data of the computer-implemented lesion detection processing.

The determination section 401 may determine, corresponding to the type of lesion detection processing, whether to perform the computer-implemented lesion detection processing. The type of lesion detection processing is determined by the subject, the imaging site, the type of imaging apparatus, and the like. For example, the types of lesion detection processing include AI lesion detection processing of a chest image which is an X-ray still image, AI lesion detection processing of a breast image, and the like.

Furthermore, the determination section 401 can directly determine, using the trained model, whether to perform the lesion detection processing. Specifically, the trained model is a model trained by machine learning using a data set including a pair of an image appropriate or inappropriate for lesion detection processing and a correct label indicating information indicating whether the image is appropriate or inappropriate for lesion detection processing. Preferably, the trained model is a model trained by machine learning using a data set including a pair of at least the medical image on which specific image processing has been performed or the medical image on which image processing has not been performed and a correct label indicating information indicating whether the image is appropriate for the lesion detection processing. The determination section 401 inputs the medical image to the trained model and acquires, as an output result from the trained model, information indicating whether the medical image is appropriate or inappropriate for lesion detection processing, to determine whether to perform lesion detection processing.

The determination section 401 can determine whether to perform lesion detection processing on the basis of a trained model using, as teacher data, the medical image including at least one of the following information. The information includes, for example, whether or not it is the standard imaging condition, whether or not the medical image satisfies the specific image quality condition, and whether or not the detection target site to be the detection target of the lesion detection processing is the defect. The other information includes whether or not a foreign object that is not a target of detection is included in the medical image, and whether or not the medical image is the image imaged by a modality other than the specific modality.

For example, when the medical image is appropriate for the lesion detection processing, the analyzing section 402 performs the lesion detection processing by analyzing the medical image using the second trained model trained by machine learning. The second trained model is, for example, a model trained by machine learning using a plurality of data sets of the medical image including the lesion, and the medical image not including the lesion linked with the analysis result based on the lesion.

The output section 403 outputs the medical image on the basis of the determination of whether to perform the computer-implemented lesion detection processing on the medical image.

When the determination section 401 determines that the computer-implemented lesion detection processing is not to be performed on the medical image, the output section 403 outputs information indicating the reason, basis, and the like for the determination result to the display part 56 of the image storage apparatus 5. The user such as the doctor opens a screen capable of referring to the medical image on the display part 56 at the time of diagnosis. Therefore, it is possible to efficiently perform diagnostic work without oversight by displaying, as the image, the reason and ground of the determination result as to whether or not to perform the computer-implemented lesion detection processing on the same screen as the medical image.

### [Example of Configuration of Image Storage Apparatus 5]

Next, a configuration of the image storage apparatus 5 according to the first embodiment will be described. FIG. 3 is a diagram illustrating a block diagram of the image storage apparatus 5 according to the first embodiment. Note that description of constituent elements having common configuration and function with the mediation apparatus 4 described in FIG. 2A will be omitted or simplified.

The image storage apparatus 5 includes a server 5a and a client terminal 5b. The server 5a and the client terminal 5b are connected to each other via a LAN or the like. The server 5a includes a controller 50, an operation part 51, a storage section 53, and a communication section 54. The controller 50, the operation part 51, the storage section 53, and the communication section 54 are connected to each other via wiring such as a bus 57.

The controller 50 includes, for example, a processor such as a CPU that performs calculation and control, a memory, and the like. The controller 50 realizes processing of storing, managing, and the like medical images and the like by executing a program stored in, for example, the storage section 53 or the like.

In the present embodiment, the controller 50 functions as the acquisition section 500 and the output section 503. The processor or the like of the controller 50 realizes the functions of the acquisition section 500 and the output section 503 by executing the program stored in the storage section 53 or the like. The acquisition section 500 acquires, for example, a medical image to which an analysis result of the computer-implemented lesion detection processing, transmitted from the mediation apparatus 4, is imparted. When a request to display a predetermined medical image is accepted from the user such as the doctor, the output section 503 outputs the corresponding medical image to the client terminal 5b.

The operation part 51 includes, for example, a mouse, a keyboard, a switch, and a button. The operation part 51 accepts instructions corresponding to various types of input operation from the user, converts the accepted instruction into an operation signal, and outputs the operation signal to the controller 50.

The storage section 53 includes, for example, any storage module such as an HDD, an SSD, a ROM, and a RAM. The storage section 53 stores, for example, a system program, an application program, and various types of data. Specifically, the storage section 53 stores image data such as the medical image to which the analysis result of the lesion detection processing by the computer is added and the medical image on which the computer-implemented lesion detection processing is not performed.

The communication section 54 includes, for example, a communication module including an NIC, a receiver, and a transmitter. The communication section 54 communicates various types of information and image data with the mediation apparatus or the like via the network N1. The communication section 54 communicates the image data and the like with the client terminal 5b.

The display part 56 of the client terminal 5b is, for example, a liquid crystal display, an organic EL display, or the like. The display part 56 displays the medical image to which the analysis result of the computer-implemented lesion detection processing is added, a medical image on which the computer-implemented lesion detection processing is not performed, and the like.

### [Operation Example of Medical Information Processing System 100A]

### (1. Method of Determining Whether to Perform Rule—Based Lesion Detection Processing)

Next, the flow of the first medical information processing method in the medical information processing system 100A according to the first embodiment will be described.

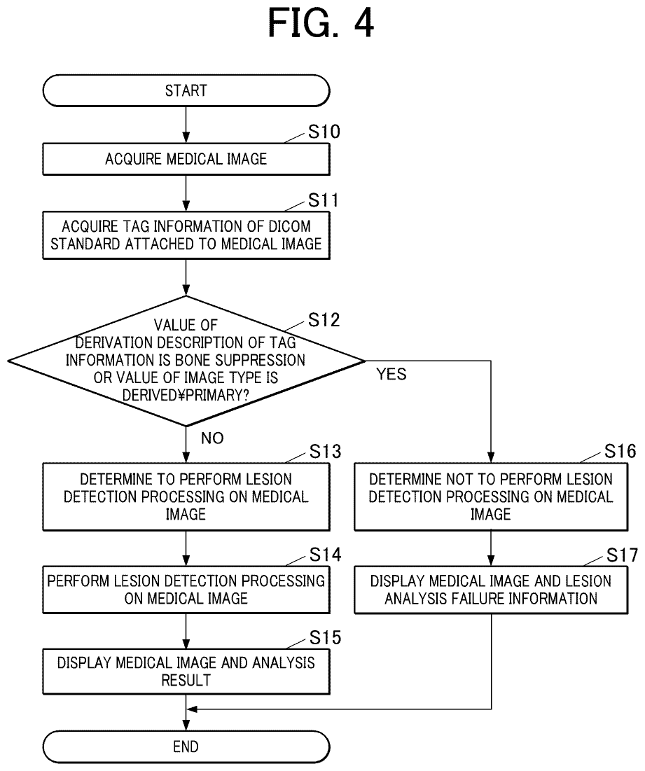

FIG. 4 is a flowchart showing an example of the operation of the medical information processing system 100A in a case of determining whether or not to execute lesion detection processing on a medical image based on a rule according to the first embodiment.

The communication section 44 of the mediation apparatus 4 acquires the medical image imaged by the imaging apparatus 3 (step S10). Step S10 corresponds to an image acquisition step. The medical image acquired by the communication section 44 is stored in the storage section 43.

The acquisition section 400 acquires tag information associated with the medical image from the acquired medical image (step S11). The tag information is defined by, for example, the DICOM standard. When the specific image processing such as rib attenuation processing has been performed on the medical image, processing information indicating that the specific image processing has been performed is added to the tag information.

The determination section 401 of the mediation apparatus 4 determines whether the content of the tag information acquired by the acquisition section 400 is information indicating the medical image suitable for computer-implemented lesion detection processing (step S12). Step S12 corresponds to a determination step. Specifically, the determination section 401 determines whether the value of “(0008,2111)_Derivation Description_derived description” defined by the DICOM standard is “BONE SUPPRESSION”.

“BONE SUPPRESSION” indicates that rib attenuation processing is being performed on the medical image. Furthermore, the determination section 401 determines whether the value of “(0008,0008)_Image Type” defined by the DICOM standard is “DERIVED Y PRIMARY”.

“DERIVEDYPRIMARY” indicates the possibility that the image is a derived image on which image processing is performed to be greatly different from that of the original image.

When the contents of the tag information are not “BONE SUPPRESSION” and “DERIVEDYPRIMARY”, the determination section 401 proceeds to step S13.

That is, the content of the tag information indicates the medical image suitable for the computer-implemented lesion detection processing. In this case, the determination section 401 determines to perform the computer-implemented lesion detection processing on the acquired medical image (step S13). Step S13 corresponds to a determination step.

The analyzing section 402 of the mediation apparatus 4 performs the computer-implemented lesion detection processing on the medical image (step S14). Specifically, the analyzing section 402 inputs the acquired medical image to the trained model, and acquires, from the trained model, the medical image to which the analysis result of the lesion is assigned as the output result. The output section 403 outputs the medical image to which the analysis result of the lesion is assigned to the communication section 44. The communication section 44 transmits the medical image to the image storage apparatus 5 via the network N1.

The acquisition section 500 of the client terminal 5b of the image storage apparatus 5 acquires the medical image or the like from the mediation apparatus 4 via the communication section 54, and stores the acquired medical image or the like in the storage section 53. When the operation part 51 accepts a search instruction for a predetermined medical image from the user such as the doctor, the acquisition section 500 acquires the corresponding medical image from the storage section 53. The output section 503 outputs the acquired medical image to the client terminal 5b. The display part 56 of the client terminal 5b displays the predetermined medical image retrieved by the user and the analysis result of the lesion given to the medical image on the screen (step S15). Thus, the user such as the doctor can quickly and accurately diagnose a patient by confirming the analysis result of a lesion displayed on the screen.

On the other hand, in step S12, when the content of the tag information is “BONE SUPPRESSION” or “DERIVEDYPRIMARY”, the determination section 401 of the mediation apparatus 4 proceeds to step S16. That is, the content of the tag information indicates the medical image that is not suitable for computer-implemented lesion detection processing.

In this case, the determination section 401 determines not to perform the computer-implemented lesion detection processing on the acquired medical image (step S16). For example, the determination section 401 adds, to the medical image, the lesion analysis failure information indicating the reason why the computer-implemented lesion detection processing cannot be performed on the acquired current medical image.

The output section 403 outputs the medical image and the lesion analysis failure information to the communication section 44. The communication section 44 transmits the medical image and the lesion analysis failure information to the image storage apparatus 5 via the network N1.

The acquisition section 500 of the client terminal 5b of the image storage apparatus 5 acquires the medical image and the like and the lesion analysis failure information from the mediation apparatus 4 via the communication section 54, and stores the acquired medical image and the like in the storage section 53. When the instruction to search for the predetermined medical image is accepted by the operation part 51 from the user, the acquisition section 500 acquires the medical image from the storage section 53. The output section 503 outputs the acquired medical image and the lesion analysis failure information to the client terminal 5b. The display part 56 of the client terminal 5b displays the predetermined medical image searched by the user and the lesion analysis failure information on the screen (step S17).

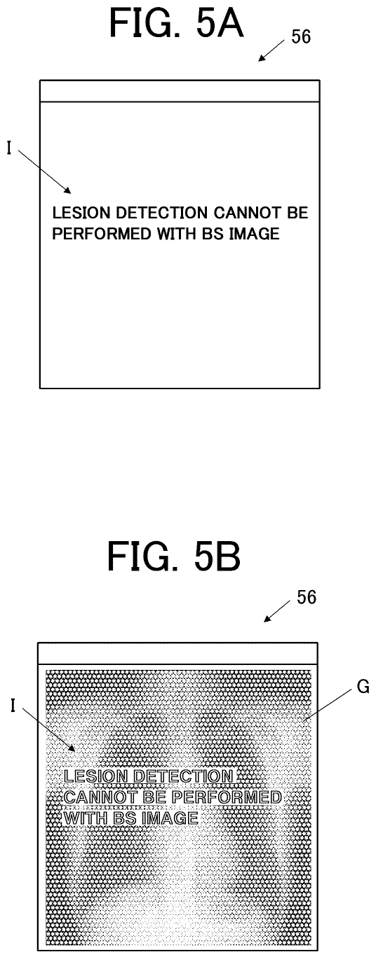

FIG. 5A is a diagram illustrating an example of lesion analysis failure information I displayed on the display part 56 of the client terminal 5b of the image storage apparatus 5 according to the first embodiment. On the screen of the display part 56, the lesion analysis failure information I is displayed which indicates the reason and the ground that the computer-implemented lesion detection processing cannot be performed with the current medical image. For example, in a case where the rib attenuation processing has already been performed on the medical image, a message “lesion detection cannot be performed on the medical image on which BS (rib attenuation) processing has been performed” is displayed as the lesion analysis failure information I on the screen of the display part 56.

FIG. 5B is a diagram illustrating another example of the lesion analysis failure information I displayed on the display part 56 of the client terminal 5b of the image storage apparatus 5 according to the first embodiment. In addition to the medical image G, the lesion analysis failure information I is displayed on the screen of the display part 56. For example, a message “lesion detection cannot be performed on the medical image on which BS processing has been performed” is superimposed and displayed as the lesion analysis failure information I on the current medical image G on the screen of the display part 56.

### (2. Method of Determining Whether to Perform Lesion Detection Processing by Trained Model)

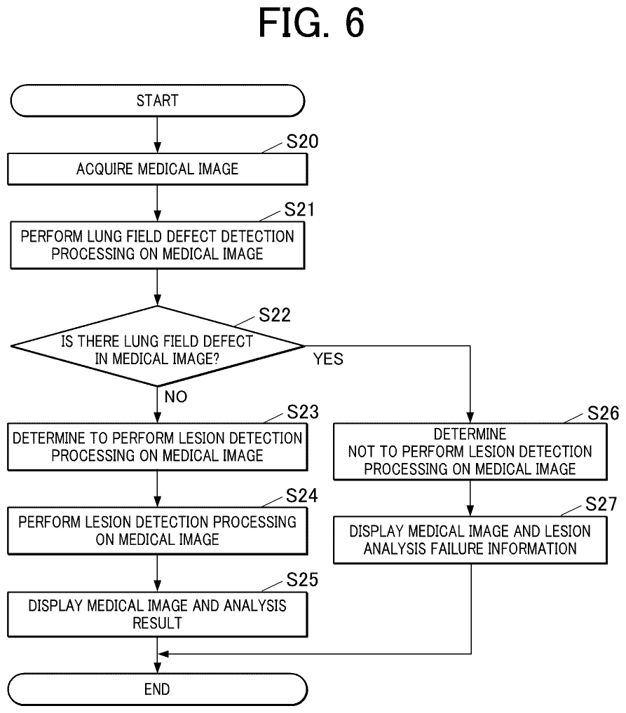

Next, a flow of a second medical information processing method in the medical information processing system 100A according to the first embodiment will be described. FIG. 6 is a flowchart illustrating an example of the operation of the medical information processing system 100A in a case of determining whether to perform lesion detection processing by using the trained model according to the first embodiment. Note that detailed description of processing common to the first medical information processing method of FIG. 4 will be omitted or simplified.

The communication section 44 of the mediation apparatus 4 acquires the medical image imaged by the imaging apparatus 3 (step S20). The medical image acquired by the communication section 44 is stored in the storage section 43.

The determination section 401 of the mediation apparatus 4 executes lung region defect detection processing on the acquired medical image (step S21). For example, the determination section 401 may execute the lung region defect detection processing of the medical image by processing based on machine learning. In one example, the technology described in Japanese Unexamined Patent Publication No. 2013-102848 is applicable to the lung region defect detection processing. Specifically, the determination section 401 calculates a predetermined first feature amount of a partial region in contact with a boundary of an irradiation field in the irradiation field in the medical image. The determination section 401 calculates, from the medical image, a predetermined second feature amount indicating the presence or absence of a high-concentration region outside the lung field. Next, the determination section 401 inputs the calculated first feature amount and second feature amount into the trained model and acquires, as an output result from the trained model, defect information on the presence or absence of the lung field defect in the medical image.

Here, the trained model can be generated by performing training using predetermined learning data with a computer having a machine learning function. Specifically, the computer prepares a plurality of images in which the lung field includes the defect and images in which the lung field does not include the defect as sample images, and calculates the first feature amount and the second feature amount from each of the sample images. The computer executes machine learning to learn from the distribution of the first feature amount and the second feature amount what boundary line should be drawn so as to be able to distinguish between the image without the defect of the lung field and the image with the defect of the lung field.

The computer outputs defect information indicating whether the image is the image without the defect or the image with the defect depending on which side of the boundary the input feature amount is positioned on. The trained model is stored in the storage section 43 of the mediation apparatus 4, for example. The algorithm of the machine learning is not particularly limited, but for example, AdaBoost, a support vector machine, a neural network, or the like can be used.

The determination section 401 of the mediation apparatus 4 determines whether the acquired medical image includes the lung field defect (step S22). When the defect information output from the trained model is information indicating “no lung field defect”, the determination section 401 determines that there is no lung field defect in the medical image and proceeds to step S23. In this case, the determination section 401 determines that the acquired medical image is to be subjected to the computer-implemented lesion detection processing (step S23).

The analyzing section 402 of the mediation apparatus 4 performs the computer-implemented lesion detection processing on the medical image (step S24). Specifically, the analyzing section 402 inputs the acquired medical image to the trained model, and acquires, from the trained model, the medical image to which the analysis result of the lesion is assigned as the output result. The communication section 44 transmits the medical image output from the output section 403 to the image storage apparatus 5 via the network N1.

The acquisition section 500 of the client terminal 5b of the image storage apparatus 5 acquires the medical image or the like from the mediation apparatus 4 via the communication section 54, and stores the acquired medical image or the like in the storage section 53. When the instruction to search for the predetermined medical image is accepted by the operation part 51 from the user, the acquisition section 500 acquires the medical image from the storage section 53. The display part 56 of the client terminal 5b displays the predetermined medical image retrieved by the user and the analysis result of the lesion given to the medical image on the screen (step S25).

On the other hand, in step S22, when the defect information output from the trained model is information indicating “there is a lung field defect”, the determination section 401 determines that there is the lung field defect in the medical image, and the process proceeds to step 526. In this case, the determination section 401 determines not to perform the computer-implemented lesion detection processing on the acquired medical image (step S26). For example, the determination section 401 adds, to the medical image, the lesion analysis failure information indicating the reason why the computer-implemented lesion detection processing cannot be performed on the acquired current medical image. The communication section 44 transmits the medical image and the lesion analysis failure information output from the output section 403 to the image storage apparatus 5 via the network N1.

The acquisition section 500 of the client terminal 5b of the image storage apparatus 5 acquires the medical image and the lesion analysis failure information from the mediation apparatus 4 via the communication section 54, and stores the acquired medical image and the like in the storage section 53. When the instruction to search for the predetermined medical image is accepted by the operation part 51 from the user, the acquisition section 500 acquires the medical image from the storage section 53. The display part 56 of the client terminal 5b displays the predetermined medical image searched by the user and the lesion analysis failure information on the screen (step S27).

### (3. Method of Determining Whether Lesion Detection Processing Using Rule—Base and Trained Model is Performed)

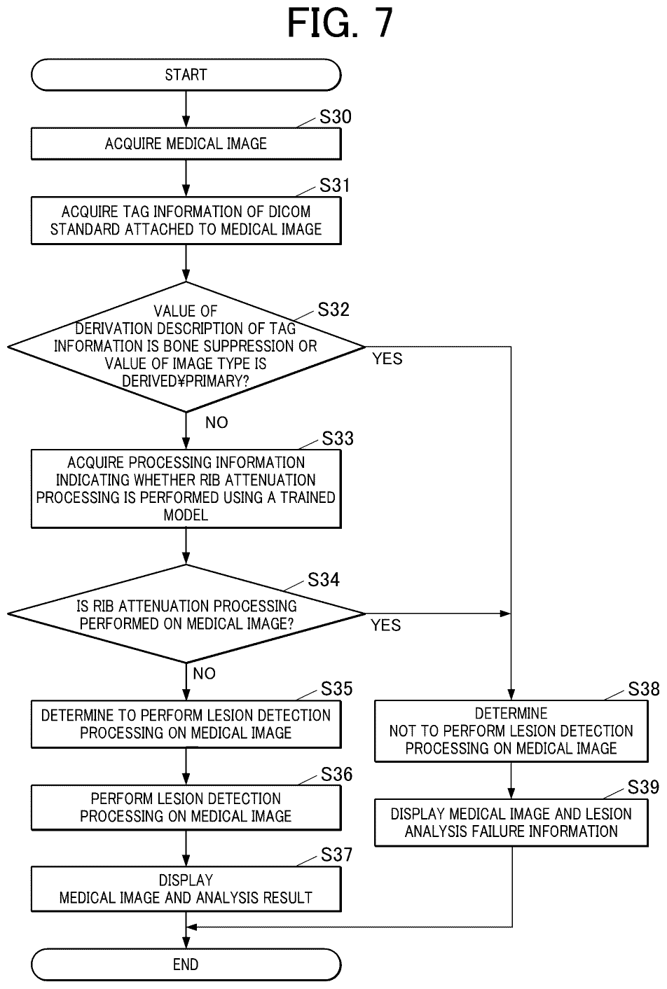

Next, a flow of a third medical information processing method in the medical information processing system 100A according to the first embodiment will be described. FIG. 7 is a flowchart illustrating an example of an operation of the medical information processing system 100A in a case in which the determination on whether to perform the lesion detection processing using the rule-based and using the trained model are combined according to the first embodiment. Note that the description of processing common to the first medical information processing method of FIG. 4 will be omitted or simplified.

The communication section 44 of the mediation apparatus 4 acquires the medical image imaged by the imaging apparatus 3 (step S30). The acquisition section 400 acquires, from the acquired medical image, the tag information of the DICOM standard associated with the medical image (step S31).

The determination section 401 of the mediation apparatus 4 determines whether the value of “(0008, 2111)_Derivation Description_Derived Description” defined by the DICOM standard of the tag information is “BONE SUPPRESSION”. Further, the determination section 401 determines whether or not the value of “(0008,0008) Image Type” defined by the DICOM standard of the tag information is “DERIVEDYPRIMARY” (step S32).

In a case in which the determination section 401 determines that the contents of the tag information is not “BONE SUPPRESSION” or “DERIVEDYPRIMARY”, the process proceeds to step S33.

The determination section 401 acquires processing information indicating whether the rib attenuation processing has been performed on the acquired medical image using the trained model (step S33). That is, in step S33, a secondary determination is performed as to whether or not the rib attenuation processing has been performed on the medical image. This is because the content of the tag information may be erroneously input. For example, the trained model is a model trained by machine learning using a data set in which the image subjected to the rib attenuation processing and processing information indicating inappropriateness for the lesion detection processing are paired. Alternatively, the trained model is a model trained by machine learning using, for example, a data set in which the image on which the rib attenuation processing has not been performed and processing information indicating appropriateness for lesion detection processing are paired.

The determination section 401 determines whether or not the rib attenuation processing has been performed on the medical image from the output result of the trained model (step S34). If the determination section 401 determines that the medical image has not been subjected to the rib attenuation processing, the process proceeds to step S34. In this case, the determination section 401 determines to perform the computer-implemented lesion detection processing on the acquired medical image (step S35).

The determination section 401 performs the computer-implemented lesion detection processing on the acquired medical image (step S36). For example, the analyzing section 402 inputs the acquired medical image to the trained model, and acquires, from the trained model, the medical image to which the analysis result of the lesion is assigned as the output result. The output section 403 outputs the medical image to which the analysis result of the lesion is assigned to the communication section 44. The communication section 44 transmits the medical image to the image storage apparatus 5 via the network N1.

The acquisition section 500 of the client terminal 5b of the image storage apparatus 5 acquires the medical image from the mediation apparatus 4 via the communication section 54. When the operation part 51 accepts a search instruction for a predetermined medical image from the user such as the doctor, the acquisition section 500 acquires the medical image from the storage section 53. The output section 503 outputs the acquired medical image to the client terminal 5b. The display part 56 of the client terminal 5b displays the predetermined medical image retrieved by the user and the analysis result of the lesion given to the medical image on the screen (step S37). Thus, the user such as the doctor can quickly and accurately diagnose a patient by confirming the analysis result of a lesion displayed on the screen.

On the other hand, in step S32, when the determination section 401 determines that the content of the tag information is “BONE SUPPRESSION” and “DERIVED/PRIMARY”, the process proceeds to step S38. Furthermore, if, in step S34, the determination section 401 determines, from the results outputted from the trained learning model, that the rib attenuation processing is to be performed on the medical image, the process proceeds to step S38. That is, this is a case in which the acquired medical image is not the medical image suitable for the computer-implemented lesion detection processing.

The determination section 401 determines not to perform the computer-implemented lesion detection processing on the acquired medical image (step S38). In this case, the determination section 401 adds, to the medical image, the lesion analysis failure information indicating that the computer-implemented lesion detection processing cannot be performed on the acquired current medical image. The output section 403 outputs the medical image and the lesion analysis failure information to the communication section 44.

The communication section 44 transmits the medical image and the lesion analysis failure information to the image storage apparatus 5 via the network N1.

The acquisition section 500 of the client terminal 5b of the image storage apparatus 5 acquires the medical image and the lesion analysis failure information from the mediation apparatus 4 via the communication section 54. When the instruction to search for the predetermined medical image is accepted by the operation part 51 from the user, the acquisition section 500 acquires the medical image from the storage section 53. The output section 503 outputs the acquired medical image and the lesion analysis failure information to the client terminal 5b. The display part 56 of the client terminal 5b displays the predetermined medical image searched by the user and the lesion analysis failure information on the screen (step S39).

### (4. Method of Determining Whether to Perform Lesion Detection Processing Using Presence or Absence of Foreign Object Detection)

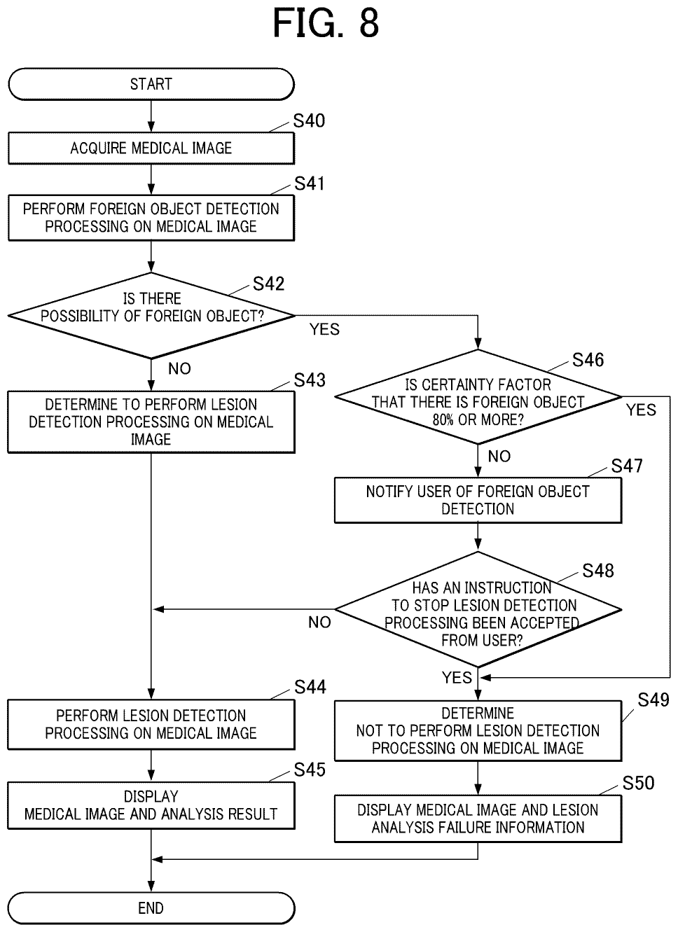

Next, a flow of a fourth medical information processing method in the medical information processing system 100A according to the first embodiment will be described. FIG. 8 is a flowchart illustrating an example of an operation of the medical information processing system 100A in a case in which the lesion detection processing is performed by the trained model according to the first embodiment. Note that description of processing common to the first medical information processing method of FIG. 4 will be omitted or simplified.

The communication section 44 acquires the medical image imaged by the imaging apparatus 3 (step S40). The medical image acquired by the communication section 44 is stored in the storage section 43.

The determination section 401 executes foreign object detection processing for detecting whether the foreign object appears in the medical image (step S41). This is because, when the computer-implemented lesion detection processing is executed using the medical image in which the foreign object appears, the detection accuracy of the lesion may be greatly reduced due to the influence of the foreign object.

The determination section 401 inputs the acquired medical image to the trained model, and acquires foreign object information indicating whether there is a possibility that the foreign object appears in the medical image as the output result from the trained model. The trained model is a model trained by machine learning using a data set of the medical image in which the foreign object appears and the foreign object information “appeared” indicating that the foreign object appears in the medical image. Alternatively, the trained model is a model trained by machine learning using, for example, a data set of the medical image in which no foreign object appears and foreign object information “no appearance” indicating that no foreign object appears in the medical image.

If the acquired foreign object information is “no appearance”, the determination section 401 determines that there is a low possibility that the foreign object appears in the medical image, and the process advances to step S43. In this case, the determination section 401 determines to perform the computer-implemented lesion detection processing on the medical image (step S43).

The determination section 401 performs the computer-implemented lesion detection processing on the acquired medical image (step S44). For example, the analyzing section 402 inputs the acquired medical image to the trained model, and acquires, from the trained model, the medical image to which the analysis result of the lesion is assigned as the output result. The output section 403 transmits the medical image to which the analysis result of the lesion is assigned to the image storage apparatus 5 via the communication section 44.

The acquisition section 500 of the client terminal 5b of the image storage apparatus 5 acquires the medical image from the mediation apparatus 4 via the communication section 54. When the operation part 51 accepts a search instruction for a predetermined medical image from the user such as the doctor, the acquisition section 500 acquires the medical image from the storage section 53. The output section 503 outputs the acquired medical image to the client terminal 5b. The display part 56 of the client terminal 5b displays the predetermined medical image retrieved by the user and the analysis result of the lesion given to the medical image on the screen (step S45). Thus, the user such as the doctor can quickly and accurately diagnose a patient by confirming the analysis result of a lesion displayed on the screen.

On the other hand, in step S42, if the acquired foreign object information indicates “appeared”, the determination section 401 determines that there is a high possibility that the foreign object appears in the medical image, and the process advances to step S46. Here, in the case in which the foreign object information is “appeared”, certainty factor information indicating a certainty factor that the foreign object appears in the medical image is further added to the foreign object information. Therefore, the determination section 401 determines, based on the certainty factor information, whether or not the certainty factor that the foreign object appears in the medical image is 80% or more (step S46).

If the certainty factor is less than 80%, the determination section 401 determines that there is a possibility that the object appearing in the medical image is not the foreign object, and the processing proceeds to step S47. The output section 403 outputs, to the display part 42, confirmation information including a message for prompting the user such as the doctor to confirm whether or not the foreign object appears in the medical image (step S47). The display part 42 displays, for example, a message such as “It is suspected that the foreign object appears. Would you like to stop the lesion detection processing because there is a possibility that the lesion detection will not be performed correctly? If the processing is to be continued, please confirm that no foreign object appears and press [No].”

The determination section 401 determines whether an instruction to stop the lesion detection processing on the medical image has been acquired (step S48). In a case in which the [No] button indicating that the lesion detection processing is not stopped is selected from the operation part 51 by the user, the determination section 401 proceeds to step S44. That is, this is a case in which the user checks the medical image and determines that no foreign object appears. In this case, as described above, the computer-implemented lesion detection processing or the like is performed on the acquired medical image.

On the other hand, in step S46, if the certainty factor is 80% or more, the determination section 401 determines that an object appearing in the medical image is the foreign object and proceeds to step S49. Furthermore, when a [Yes] button for stopping the lesion detection processing is selected from the operation part 51 by the user, the determination section 401 proceeds to step S49. That is, this is a case in which the user checks the medical image and determines that the foreign object appears in the image.

The determination section 401 determines not to perform the computer-implemented lesion detection processing on the acquired medical image (step S49). In this case, the determination section 401 adds, to the medical image, the lesion analysis failure information indicating the reason why the computer-implemented lesion detection processing cannot be performed on the acquired current medical image. The output section 403 transmits the medical image and the lesion analysis failure information to the image storage apparatus 5 via the communication section 44.

The acquisition section 500 of the client terminal 5b of the image storage apparatus 5 acquires the medical image and the lesion analysis failure information from the mediation apparatus 4 via the communication section 54. When the instruction to search for the predetermined medical image is accepted by the operation part 51 from the user, the acquisition section 500 acquires the medical image from the storage section 53. The output section 503 outputs the acquired medical image and the lesion analysis failure information to the client terminal 5b. The display part 56 of the client terminal 5b displays the predetermined medical image searched by the user and the lesion analysis failure information on the screen (step S50).

According to the first embodiment, before the computer-implemented lesion detection processing is performed on the medical image, it is determined whether the computer-implemented lesion detection processing is to be performed. That is, before the computer-implemented lesion detection processing is performed, the medical image is subjected to filtering processing for determining whether the medical image is suitable for the computer-implemented lesion detection processing. Thus, the computer-implemented lesion detection processing can be performed only on the medical image suitable for the computer-implemented lesion detection processing. As a result, it is possible to prevent an inaccurate analysis result from being provided to the user such as the doctor and the doctor or the like can reliably avoid oversight, misdiagnosis, and the like of the lesion.

Furthermore, according to the first embodiment, before the computer-implemented lesion detection processing is performed, the filtering processing for determining whether the medical image is suitable for the computer-implemented lesion detection processing is performed on the medical image. That is, the lesion detection processing is not performed on all the medical images, but the lesion detection processing is performed only on a specific medical image. Thus, since unnecessary processing in the analyzing section 402 can be omitted, the load on the mediation apparatus 4 can be reduced, and the lesion detection processing and the like can be made more efficient.

Furthermore, according to the first embodiment, when the medical image is determined to be inappropriate for the computer-implemented lesion detection processing, the reason and basis therefor are displayed as the lesion analysis failure information I on the client terminal 5b with which the doctor or the like refers to the medical image. Therefore, the user such as the doctor can accurately understand whether abnormality of the lesion has not been detected in the computer-implemented lesion detection processing or the medical image is inappropriate for the computer-implemented lesion detection processing. Thus, the user such as the doctor can make an appropriate diagnosis.

### Second Embodiment

In the medical information processing system 100B of the second embodiment, the computer-implemented lesion detection processing is performed by the image analysis apparatus on a cloud. Hereinafter, differences from the first embodiment will be mainly described, and description of points common to the first embodiment will be omitted. In the description of the second embodiment, portions having common configurations and functions as those of the first embodiment will be described with the same reference numerals.

### [Example Configuration of Medical Information Processing System 100B]

FIG. 9 is a diagram showing an example of a schematic configuration of the medical information processing system 100B according to the second embodiment. The medical information processing system 100B includes an in-facility system 10 disposed in a hospital facility and an image analysis apparatus 9 provided on the cloud. The in-facility system 10 includes a hospital information system 1, a radiology information system 2, an imaging apparatus 3, a mediation apparatus 4, and an image storage apparatus 5. The in-facility system 10 and the image analysis apparatus 9 are communicably connected to each other via a network N2. The network N2 includes, for example, the Internet and a WAN. WAN is an abbreviation for Wide Area Network. The image analysis apparatus 9 may be provided not only on the cloud via the network N2 but also in a network N1 within a medical facility.

### [Operation Example of Medical Information Processing System 100B]

The imaging apparatus 3 of the in-facility system 10 receives the examination order from the hospital information system 1 or the like and acquires a medical image of an imaging site by imaging a subject. The mediation apparatus 4 determines whether to perform the computer-implemented lesion detection processing on the medical image acquired by the imaging apparatus 3. For example, the mediation apparatus 4 determines whether to perform lesion detection processing on the basis of at least a condition indicating whether specific image processing has been performed, or determines whether to perform the lesion detection processing using the trained model. If the mediation apparatus 4 determines that the computer-implemented lesion detection processing is to be performed on the medical image acquired by the imaging apparatus 3, the mediation apparatus 4 transmits the medical image to the image analysis apparatus 9 on the cloud via the network N2. On the other hand, when the mediation apparatus 4 determines that the computer-implemented lesion detection processing is not to be performed on the medical image acquired by the imaging apparatus 3, the mediation apparatus 4 adds lesion analysis failure information to the medical image and stores the medical image in the image storage apparatus 5.

The image analysis apparatus 9 on the cloud includes a function as the analyzing section 402 of the mediation apparatus 4 of the first embodiment. The image analysis apparatus 9 performs the computer-implemented lesion detection processing on the medical image acquired from the mediation apparatus 4 of the in-facility system 10. The image analysis apparatus 9 inputs, for example, the acquired medical image to the trained model, and obtains, from the trained model, the medical image to which the analysis result of the lesion is assigned. The image analysis apparatus 9 transmits the acquired medical image provided with the analysis result of the lesion to the mediation apparatus 4 of the in-facility system 10 via the network N2.

The mediation apparatus 4 receives the medical image to which the analysis result of the lesion transmitted from the image analysis apparatus 9 on the cloud is imparted, and transmits the received medical image to the image storage apparatus 5. The image storage apparatus 5 stores the medical image to which the analysis result of the lesion transmitted from the mediation apparatus 4 is assigned. When a search instruction for a predetermined medical image is accepted from the user such as the doctor, the image storage apparatus 5 outputs the medical image to the client terminal 5b. The client terminal 5b displays, on the screen of the display part 56, the predetermined medical image retrieved by the user and the analysis result of the lesion given to the medical image. On the other hand, when the lesion detection processing has not been performed on the medical image, the client terminal 5b displays, on the screen, information indicating the reason why the lesion detection processing of the medical image for which the search request has been made is inappropriate and the basis thereof.

According to the second embodiment, the same effects as those of the above-described first embodiment can be exhibited. Furthermore, conventionally, in a case in which the computer-implemented lesion detection processing is performed by the apparatus on a cloud, if all medical images are transmitted, there may be medical images not suitable for the computer-implemented lesion detection processing. In this case, there is a problem in that unnecessary communication or arithmetic processing accompanied by the lesion detection processing occurs. In particular, when the image analysis apparatus 9 is provided on the cloud, a cost corresponding to the amount of data generated in communication and a CPU usage fee due to the calculation of the lesion detection processing may be generated. Therefore, if all the medical images are uploaded to the cloud, unnecessary costs may be incurred. According to the second embodiment, even when the image analysis apparatus 9 is provided on the cloud, only the medical image suitable for the computer-implemented lesion detection processing is transmitted with respect to the medical images, thus making it possible to suppress unnecessary communication and arithmetic processing accompanied by the lesion detection processing. Thus, it is possible to avoid unnecessary costs.

### Third Embodiment

In the medical information processing system 100C according to the third embodiment, the computer-implemented lesion detection processing is performed by the image analysis apparatus 9 on the cloud, and the image imaging storage apparatus 8 in which the image imaging apparatus and the image storage apparatus are integrated is constructed. Hereinafter, differences from the first embodiment will be mainly described, and description of points common to the first embodiment and the second embodiment will be omitted. Note that in the description of the third embodiment, the same parts as those in the first embodiment will be described with the same reference numerals.

### [Example Configuration of Medical Information Processing System 100C]

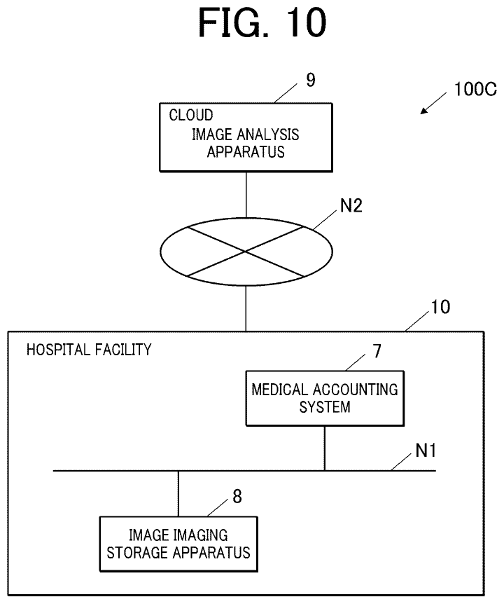

FIG. 10 is a diagram showing an example of a schematic configuration of the medical information processing system 100C according to the third embodiment. The medical information processing system 100C includes an in-facility system 10 disposed in a hospital facility and an image analysis apparatus 9 provided on the cloud. The in-facility system 10 includes a medical accounting system 7 and an image imaging storage apparatus 8. The medical accounting system 7 is a system in which the hospital information system 1 and the radiology information system 2 of the first embodiment are integrated. The image imaging storage apparatus 8 is an apparatus in which the imaging apparatus 3 and the image storage apparatus 5 of the first embodiment are integrated.

### [Example of Configuration of Image Imaging Storage Apparatus 8]

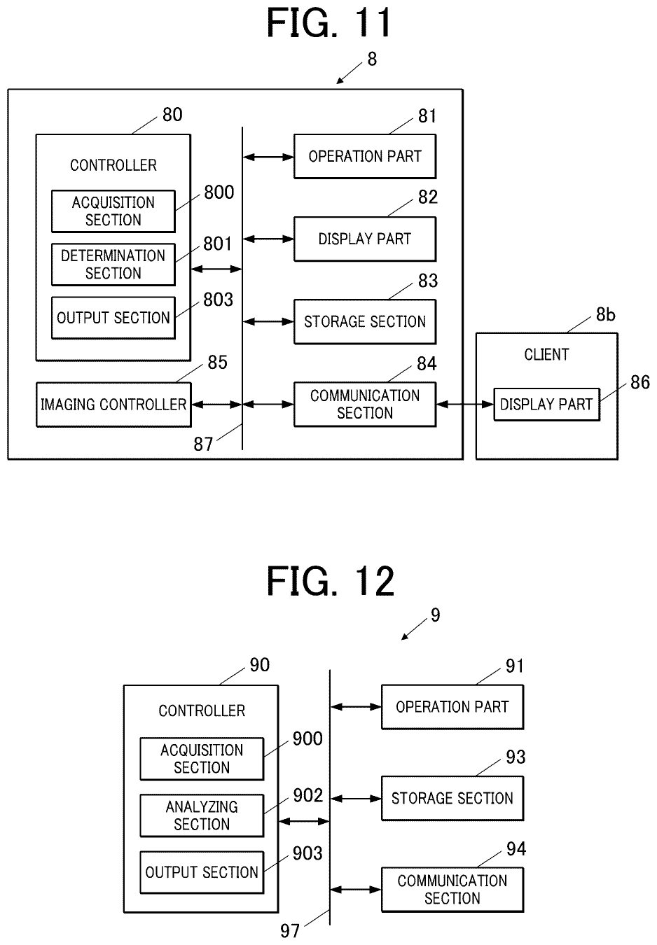

Next, a configuration of the image imaging storage apparatus 8 according to the third embodiment will be described. FIG. 11 is a block diagram of the image imaging storage apparatus 8 according to the third embodiment. The image imaging storage apparatus 8 includes a controller 80, an operation part 81, a display part 82, a storage section 83, a communication section 84, and an imaging controller 85. The controller 80, the operation part 81, the display part 82, the storage section 83, the communication section 84, and the imaging controller 85 are connected to each other via wiring such as a bus 87. The controller 80 functions as an acquisition section 800, a determination section 801, and an output section 803. The imaging controller 85 operates as an image acquisition section (image acquirer), and acquires a predetermined medical image by imaging a subject. A client terminal 8a having a display part 86 is connected to the image imaging storage apparatus 8.

### [Configuration Example of Image Analysis Apparatus 9]

Next, a configuration of the image imaging storage apparatus 8 according to the third embodiment will be described. FIG. 12 is a diagram illustrating a block diagram of the image imaging storage apparatus 8 according to the third embodiment. The image analysis apparatus 9 includes a controller 90, an operation part 91, a storage section 93, and a communication section 94. The controller 90, the operation part 91, the storage section 93, and the communication section 94 are connected to each other via wiring such as a bus 97. The controller 90 functions as an acquisition section 900, an analyzing section 902, and an output section 903.

### [Operation Example of Medical Information Processing System 100C]

The imaging controller 85 of the image imaging storage apparatus 8 receives the examination order from the medical accounting system 7 or the like, and acquires the medical image of the imaging site by imaging the subject. The medical image acquired by the imaging controller is stored in the storage section 83. Here, when the user such as the doctor requests the lesion detection processing of the predetermined image, the predetermined image is selected on the screen displayed on the display part 82, and a request operation of the lesion detection processing is performed. The determination section 801 reads the medical image selected by the user from the storage section 83, and determines whether to perform the computer-implemented lesion detection processing on the read medical image. For example, the determination section 801 determines whether to perform the lesion detection processing on the basis of at least a condition indicating whether specific image processing has been performed, or determines whether to perform the lesion detection processing using the trained model. When determining to perform the computer-implemented lesion detection processing on the medical image, the output section 803 transmits the medical image to the image analysis apparatus 9 on the cloud via the network N2. On the other hand, if the determination section 801 determines not to perform the computer-implemented lesion detection processing on the medical image, it adds lesion analysis failure information to the medical image and stores it in the storage section 83.

The image analysis apparatus 9 includes a function as the analyzing section 402 of the mediation apparatus 4 of the first embodiment. The image analysis apparatus 9 performs computer-implemented lesion detection processing on the medical image acquired from the image imaging storage apparatus 8 of the in-facility system 10. The image analysis apparatus 9 inputs, for example, the acquired medical image to the trained model, and obtains, from the trained model, the medical image to which the analysis result of the lesion is assigned. The image analysis apparatus 9 transmits the acquired medical image provided with the analysis result of the lesion to the image imaging storage apparatus 8 of the in-facility system 10 via the network N2.

The communication section 84 of the image imaging storage apparatus 8 receives the medical image to which the analysis result of the lesion is assigned from the image analysis apparatus 9 on the cloud. The acquisition section 800 stores the received medical image to which the analysis result of the lesion is assigned in the storage section 83. The output section 803 outputs the medical image to which the analysis result of the lesion is assigned to the client terminal 5b. The display part 56 of the client terminal 5b displays, on the screen of the display part 56, the predetermined medical image retrieved by the user and the analysis result of the lesion given to the medical image.

On the other hand, when the lesion detection processing has not been performed on the medical image, the client terminal 5b displays, on the screen, information indicating the reason why the lesion detection processing of the medical image for which the search request has been made is inappropriate and the basis thereof.

According to the third embodiment, the same effects as those of the above-described first embodiment can be exhibited. Furthermore, conventionally, in a case in which the computer-implemented lesion detection processing is performed by the apparatus on a cloud, if all medical images are transmitted, there may be medical images not suitable for the computer-implemented lesion detection processing. In this case, there is a problem that unnecessary communication, load, and the like occur. In particular, in a case in which the image analysis apparatus 9 is provided on the cloud, a usage fee may be incurred according to the amount of processing, time, and the like. Therefore, if all the medical images are uploaded to the cloud, unnecessary costs may be incurred. According to the third embodiment, even when the image analysis apparatus 9 is provided on the cloud, only the medical image suitable for the computer-implemented lesion detection processing is transmitted with respect to the medical images, so that unnecessary communication and processing can be suppressed. Thus, it is possible to avoid unnecessary costs.

Although the preferred embodiments of the present disclosure have been described in detail with reference to the accompanying drawings, the technical scope of the present disclosure is not limited to such examples. Furthermore, those to which various modification examples and improvements have been applied naturally belong to the technical scope of the present disclosure within the category of the technical idea described in the scope of the claims of those skilled in the art.

For example, medical images suitable for the computer-implemented lesion detection processing may be limited to medical images intended for adults. The fact that the medical image is not intended for children is judged from age information at the time of imaging, which is calculated from any of the date of examination, the date of series, the date of image, and the date of collection in the tag information appended to the medical image according to the DICOM standard and the date of birth of the patient.

Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-041865, filed on Mar. 18, 2024, including description, claims, drawings and abstract is incorporated herein by reference.

What is claimed is:

1. A medical information processing apparatus comprising:
an image acquirer that acquires a medical image; and
a hardware processor that determines whether to perform lesion detection processing by a computer on the medical image,
wherein the hardware processor determines whether to perform the lesion detection processing based on at least a condition as to whether specific image processing has been performed, or determines whether to perform the lesion detection processing using a trained model.

2. The medical information processing apparatus according to claim 1, wherein the hardware processor outputs the medical image based on a determination of whether to make the determination.

3. The medical information processing apparatus according to claim 1, wherein,
the hardware processor acquires information on whether the specific image processing has been performed by supplementary information of the medical image or image recognition of the medical image, and
the hardware processor determines whether to perform the lesion detection processing based on at least a condition of whether the specific image processing is performed using the acquired information of whether the specific image processing is performed.

4. The medical information processing apparatus according to claim 1, wherein,
the hardware processor acquires information on whether the specific image processing has been performed from information included in a hospital information system or information included in a radiology information system, and
the hardware processor determines whether to perform the lesion detection processing based on at least a condition of whether the specific image processing is performed using the acquired information of whether the specific image processing is performed.

5. The medical information processing apparatus according to claim 1, wherein the trained model is the trained model using a data set in which at least the medical image on which the specific image processing has been performed or the medical image on which the image processing has not been performed is paired with a correct label.

6. The medical information processing apparatus according to claim 1, wherein the specific image processing is at least one processing selected from a group of processing including up-down and left-right inversion processing, rotation processing, black and white inversion processing, For Processing processing, bone-weakening processing, time-dependent subtraction processing, energy subtraction processing, outside-irradiation-field blackening processing, frequency processing of a certain intensity or higher, addition of a digital marker, and addition of an annotation.

7. The medical information processing apparatus according to claim 1, wherein the hardware processor determines whether to perform lesion detection processing by the computer on the medical image based on at least one of the following conditions including, whether it is a standard imaging condition, whether the medical image satisfies a specific image quality condition, whether a detection target site which is to be a detection target of the lesion detection processing is a defect, whether the medical image includes a foreign object which is not the detection target, and whether the medical image is an image imaged by a modality other than a specific modality.

8. The medical information processing apparatus according to claim 1, wherein the hardware processor determines whether to perform the lesion detection processing using a trained model using, as teacher data, the medical image including information on at least one of whether an imaging condition is a standard imaging condition, whether the medical image satisfies a specific image quality condition, whether a detection target site which is to be a detection target of the lesion detection processing is a defect, whether the medical image includes a foreign object which is not the detection target, and whether the medical image is an image imaged by a modality other than a specific modality.

9. The medical information processing apparatus according to claim 7, wherein whether the standard imaging condition is, whether an inclination of the medical image satisfies a condition, whether the medical image is a portable imaged image, whether the medical image is an enlarged imaged image, whether the medical image is a spot imaged image, whether an imaging body position of a subject of the medical image satisfies the condition, whether a dose information of the medical image satisfies a condition, and whether the medical image is an image in which moire occurs.

10. The medical information processing apparatus according to claim 7, wherein whether the medical image satisfies the specific image quality condition is at least one of whether the medical image is a film digitized image, whether a resolution of the medical image satisfies a condition, and whether a lossy compression processing is performed.

11. The medical information processing apparatus according to claim 7, wherein whether the detection target site which is to be the detection target of the lesion detection processing is the defect is at least one of whether the medical image is a lung field defect image and whether the medical image is an image in which an imaging target site is cut out of the medical image.

12. The medical information processing apparatus according to claim 7, wherein whether the medical image includes the foreign object which is not the detection target is at least one of whether the medical image includes a foreign object other than a living body and whether the medical image includes a large lesion.

13. The medical information processing apparatus according to claim 1, wherein whether the medical image is the image imaged by a modality other than a specific modality is whether the medical image is at least one of a tomographic image, an ultrasonic image, and a moving image.

14. The medical information processing apparatus according to claim 1, wherein the hardware processor determines whether to perform the lesion detection processing by the computer on the medical image based on whether the medical image has been imaged under a specific imaging condition other than an imaging direction or an imaging site.

15. The medical information processing apparatus according to claim 7 wherein,
the hardware processor acquires, from tag information of the medical image, at least one information of whether the specific image processing is performed, whether it is the standard imaging condition, whether the medical image satisfies the specific image quality condition, and whether the medical image is the image imaged by the modality other than the specific modality, and
the hardware processor determines whether to perform the lesion detection processing using the information acquired from the tag information.

16. The medical information processing apparatus according to claim 7, wherein,
the hardware processor acquires, from image recognition of the medical image, at least one information of whether the specific image processing is performed, whether it is the standard imaging condition, whether the medical image satisfies the specific image quality condition, whether the detection target site which is to be the detection target of the lesion detection processing is the defect, whether the medical image includes the foreign object which is not the detection target, and whether the medical image is the image imaged by the modality other than the specific modality, and
the hardware processor determines whether to perform the lesion detection processing using the information recognized from the image recognition.

17. The medical information processing apparatus according to claim 7, wherein the hardware processor acquires, by image recognition on the medical image, at least one of information on whether the detection target site which is to be the detection target of the lesion detection processing is the defect and whether the foreign object which is not to be the detection target is included in the medical image.

18. The medical information processing apparatus according to claim 1, wherein the hardware processor makes a determination corresponding to a type of the lesion detection processing.

19. The medical information processing apparatus according to claim 2, wherein, in a case in which it is determined that the lesion detection processing is not performed, the hardware processor outputs information regarding such determination.

20. A medical information processing system comprising:
an image acquirer that acquires a medical image; and
a hardware processor that determines whether to perform lesion detection processing by a computer on the medical image,
wherein the hardware processor determines whether to perform the lesion detection processing based on at least a condition as to whether specific image processing has been performed, or determines whether to perform the lesion detection processing using a trained model.

21. A medical information processing method comprising:
acquiring a medical image; and
determining whether to perform lesion detection processing by a computer on the medical image,
wherein, in the determining, whether to perform the lesion detection processing is determined based on at least a condition as to whether specific image processing has been performed, or whether to perform the lesion detection processing is determined using a trained model.

22. A non-transitory computer-readable storage medium storing a program that causes a computer to perform:
acquiring a medical image, and
determining whether to perform lesion detection processing by a computer on the medical image,
wherein, in the determining, whether to perform the lesion detection processing is determined based on at least a condition as to whether specific image processing has been performed, or whether to perform the lesion detection processing is determined using a trained model.
